(19) United States
(12) Patent Application Publication
(10) Pub. No.: US 2011/0206312 A1
(43) Pub. Date: Aug. 25, 2011

(54) ENDCAP FOR WHEEL BEARING ASSEMBLY

(75) Inventor: Jeffrey W. Schumacher, North Canton, OH (US)

(73) Assignee: THE TIMKEN COMPANY, Canton, OH (US)

(21) Appl. No.: 13/125,183

(22) PCT Filed: Oct. 29, 2009
(86) PCT No.: PCT/US09/62472

§ 371 Date: Apr. 20, 2011

Related U.S. Application Data
(60) Provisional application No. 61/109,555, filed on Oct. 30, 2008.

(51) Int. Cl. F16C 41/00

(52) U.S. Cl. 384/624

(57) ABSTRACT

A wheel bearing assembly endcap 200 configured with a pilot structure 202 defined by radially-inner and radially-outer annular portions 202a, 202b joined by an annular bend 202c disposed between a central face 204 of the endcap and an outer peripheral flange 206. The pilot structure 202 projects in an axially outboard direction along the axis X of the wheel bearing assembly 100 for fitment within an inner diameter surface 112 of an outer axial member 106, to facilitate sealing and a spring-biased retention of the endcap 200 within the wheel bearing assembly 100. The outer peripheral flange 206, which is contiguous with the pilot structure 202, seats against an inboard end face 114 of the wheel bearing assembly 100 outer axial member 106 to provide a positive axial stop, and is configured as an additional sealing element to reduce contaminate ingress between the endcap 200 and the interior surfaces of the wheel bearing assembly 100.

### CROSS-REFERENCE TO RELATED APPLICATIONS

The present application is related to, and claims priority from, U.S. Provisional Patent Application Ser. No. 61/109,555 filed on Oct. 30, 2008, which is herein incorporated by reference.

### STATEMENT REGARDING FEDERALLY SPONSORED RESEARCH

Not Applicable.

### BACKGROUND OF THE INVENTION

The present invention is related generally to vehicle wheel bearing assemblies, and in particular, to an endcap configured to seal an inboard face of a vehicle wheel bearing assembly from the environment.

On vehicle wheel bearing applications, endcaps are utilized to seal the inboard side or face of the wheel bearing from exposure to the external environment. The use of endcaps to replace traditional seals reduces cost and improves sealing performance, retaining lubricant within the bearing assembly and preventing contaminate ingress. Endcaps are commonly retained on the wheel bearing by a press fit of an annular pilot portion of the outer peripheral edge of the endcap into an inner diameter of the wheel bearing, with the endcap annular pilot and wheel bearing inner diameter interface providing both endcap retention and sealing functionality.

Accordingly, it would be advantageous to provide an endcap with features for improved retention and/or sealing functionality over that achieved with a traditional endcap pilot/bearing inner diameter interface.

### BRIEF SUMMARY OF THE INVENTION

Briefly stated, the present disclosure provides a vehicle wheel bearing assembly endcap configured with an annular pilot defined by an annular fold disposed between a central face of the endcap and a radially extending outer peripheral flange. The annular fold projects axially outward along the axis of the vehicle wheel bearing assembly, having a radially-inside annular portion and a radially-outside annular portion which cooperatively define a resilient annular spring element. The resilient annular spring element is adapted to facilitate retention of the endcap pilot within an inner diameter of the wheel bearing assembly by biasing the radially-outside annular portion against an inner diameter surface of the wheel bearing assembly. The outer peripheral flange, which is contiguous with the radially-outside annular portion of the endcap pilot, seats against an outboard end face of the vehicle wheel bearing assembly to provide a positive axial stop, and functions as a seal to reduce contaminate ingress between the radially-outside annular portion of the endcap pilot and the inner diameter surface of the wheel bearing assembly.

In one embodiment, the endcap of the present disclosure is further adapted to enable an external sensor to obtain signals through the endcap structure, from an encoder disposed axially behind the endcap central face, between the endcap pilot radially-inside annular portion and an inner race of a bearing assembly contained within the wheel bearing assembly. Spacing between the endcap pilot radially-inside annular portion and radially-outside annular portions is selected to accommodate the encoder as required.

In an alternate embodiment, the outer peripheral flange of the endcap of the present disclosure is configured to extend past, and wrap around, an outer diameter surface of the wheel bearing assembly, further facilitating the sealing of the wheel bearing assembly from external contaminates. The peripheral edge of the outer peripheral flange may be flared and/or fitted to the outer diameter surface of the wheel bearing to facilitate placement and retention there of.

In an alternate embodiment of the endcap of the present disclosure, the radially-outside annular portion of the annular fold forming the endcap pilot includes a feature adapted to positively engage the inner diameter surface of the wheel bearing assembly. The feature may include a radially enlarged transition between the radially-inside annular portion and the radially-outside annular portion, or an incline of the radially-outside annular portion relative to the wheel bearing assembly rotational axis, such that the endcap pilot has a tapered outer surface for deflecting engagement with the inner peripheral surface of the wheel bearing.

In further alternate embodiments of the endcap of the present disclosure, one or more seals, gaskets, or sealing materials are disposed between the endcap surfaces and the wheel bearing assembly components to facilitate sealing.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a partial sectional view of a wheel bearing assembly configured with an endcap of the present disclosure and a pass-through sensor and encoder;

FIG. 2 is an enlarged view of the endcap pilot, outer peripheral flange, and encoder shown in FIG. 1;

FIG. 3 is an enlarged view, similar to FIG. 2, of an alternate embodiment endcap incorporating an extended outer peripheral flange;

FIG. 4 is an enlarged view, similar to FIG. 3, wherein the extended endcap outer peripheral flange is fitted to a recessed annular region on an outer diameter surface of the wheel bearing assembly;

FIG. 5 is an enlarged view, similar to FIG. 3, wherein the extended endcap outer peripheral flange is outwardly flared at a peripheral edge;

FIG. 6 is an enlarged view, similar to FIG. 2, wherein the radially-outside annular portion of the endcap pilot includes an exaggerated transition from the radially-inside annular portion to define an annular bulge to seat within a recessed portion of the wheel bearing assembly inner diameter surface;

FIG. 7 is an enlarged view, similar to FIG. 2, wherein the radially-outside annular portion of the endcap pilot is inclined relative to the rotational axis of the wheel bearing assembly, defining a tapered surface in engagement with a matching wheel bearing assembly inner diameter surface;

FIG. 8 is an enlarged view, similar to FIG. 2, illustrating the inclusion of an elastic member between the outer peripheral flange of the endcap and the wheel bearing assembly inboard face;

FIG. 9 is an enlarged view, similar to FIG. 2, illustrating the inclusion of an elastic gasket between the outer peripheral flange of the endcap and the wheel bearing assembly inboard face;

FIG. 10 is an enlarged view, similar to FIG. 2, illustrating the inclusion of a recessed O-ring gasket disposed between the outer peripheral flange of the endcap and the wheel bearing assembly inboard face;

FIG. 11 is an enlarged view, similar to FIG. 2, illustrating the inclusion of an elastic member between an extended portion the outer peripheral flange of the endcap and the wheel bearing assembly outer surface;

FIG. 12 is an enlarged view, similar to FIG. 11, illustrating the inclusion of a recessed O-ring gasket between an extended portion the outer peripheral flange of the endcap and the wheel bearing assembly outer surface; and

FIG. 13 is an enlarged view, similar to FIG. 2, illustrating the use of a stamped steel retaining ring to further secure the pilot structure within the inner diameter surface of the outer axial member.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

Turning to the figures, and to FIG. 1 initially, a wheel bearing assembly 100 having a inner axial member 102 rotationally supported about an axis X by an annular bearing assembly 104 relative to a outer axial member 106 is shown in partial sectional view with an endcap 200 axially disposed on the inboard end of the wheel bearing assembly 100. Preferably, as shown in the figures, and in FIG. 1 in particular, the endcap 200 is adapted to enable an external sensor 108 to obtain signals through the structure of the endcap 200, from an encoder 110 disposed within the wheel bearing assembly 104 under the endcap 200, and which rotates with the inner axial member 102. For encoders 110 and sensors 108 utilizing varying magnetic fields to provide data associated with the rotation movement of the inner axial member 102 or other forces effecting the inner axial member 102, the endcap 200 may be composed of a non-magnetic material, such as a non-magnetic steel or plastic. Preferably, the endcap 200 is configured to minimize the air gap between the endcap 200 and the enclosed encoder 110, to facilitate detection of the encoder signal by the external sensor 108.

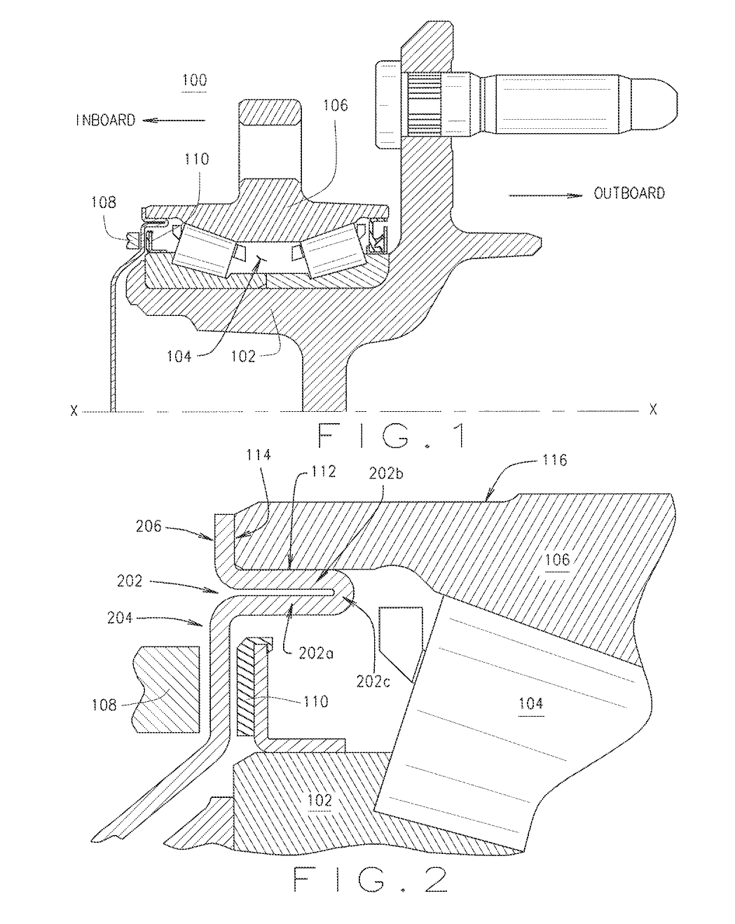

The endcap 200 is retained on the outer member 106 of the wheel bearing assembly 100 with a pilot structure 202, best seen in FIG. 2, defined by an annular fold disposed between a generally convex central surface 204 of the endcap 200 and an generally flat outer peripheral flange 206. The annular fold projects in the outboard direction, parallel to the axis X of the wheel bearing assembly 100, and includes a radially-inside annular portion 202a and a radially-outside annular portion 202b joined by an annular bend 202c. The pilot structure 202 is contiguously formed with the endcap central surface 204 and outer peripheral flange 206, and functions to define a resilient annular spring means adapted to facilitate retention of the endcap 200 within an inner diameter surface 112 of the wheel bearing assembly 100 outer axial member 106. The resilient annular spring means defined by the pilot structure 202 biases the radially-outside annular portion 202b of the pilot structure 202 against the inner diameter surface 112 of the wheel bearing assembly 100 outer axial member 106. The radial spacing between the endcap pilot radially-inside annular portion 202a and the radially-outside annular portion 202b of the axially inner member is selected to accommodate the encoder 110, and to achieve a desired degree of elasticity, and may be varied as required by increasing or decreasing the size and shape of the annular bend portion 202c.

The outer peripheral flange 206, which is contiguous with the radially-outside annular portion 202b of the endcap pilot 202, extends in a radially outward direction, and seats against an inboard end face 114 of the wheel bearing assembly 100 outer axial member 106 to provide a positive stop for the endcap 200 in the axially outboard direction. In addition to providing the endcap 200 with a positive stop, the outer peripheral flange 206 functions as a sealing member to both retain lubricant within the wheel bearing assembly 100, and to reduce contaminate ingress between the radially-outside annular portion 202b of the endcap pilot 202 and the inner diameter surface 112 of the wheel bearing assembly 100 outer axial member 106.

It will be recognized by those of ordinary skill in the art that the base design of the endcap 200 as set forth and described herein in connection with FIGS. 1 and 2, which incorporates both an endcap pilot structure 202 and a contiguously formed endcap outer peripheral flange 206 to facilitate retention and sealing, may be modified and adapted to provide additional endcap retention and sealing functionality without departing from the scope of the invention. Several exemplary embodiments and variations are described below in connection with the various figures.

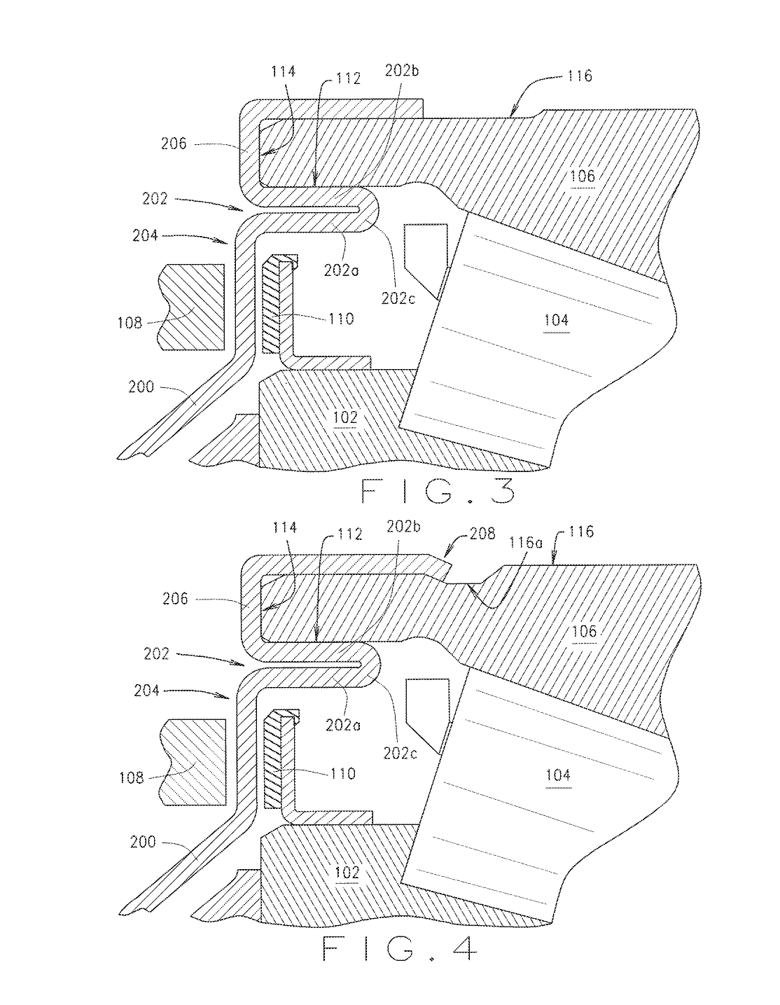

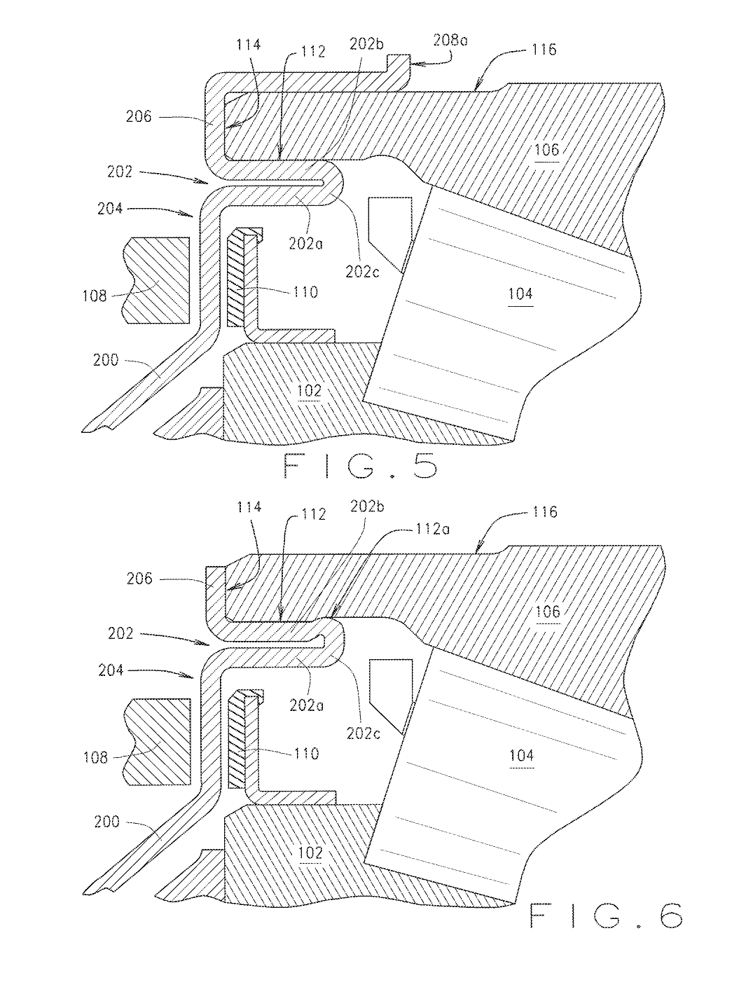

In order to increase the sealing functionality of the endcap 200 of the present disclosure, the outer peripheral flange 206 may be configured to extend radially outward beyond the outer diameter of the outer axial member 106, with an extended outer annular flange 206a fitted against an outer peripheral surface 116 of the outer axial member 106, as best seen in FIG. 3. To facilitate retention of the endcap 200 on the outer axial member 106, the outboard end 208 of the extended outer annular flange 206a may be crimped to engage an annular retaining recess 116a on the outer peripheral surface 116, as shown in FIG. 4. Conversely, to facilitate installation and removal of the endcap 200 from the outer axial member 106, the outerboard end 208 of the extended outer annular flange 206a may be flared or rolled radially outward to form a lip 208a, as shown in FIG. 5. The lip 208a may be engaged or gripped by various tools during installation and/or removal of the endcap 200 from the wheel bearing assembly 100.

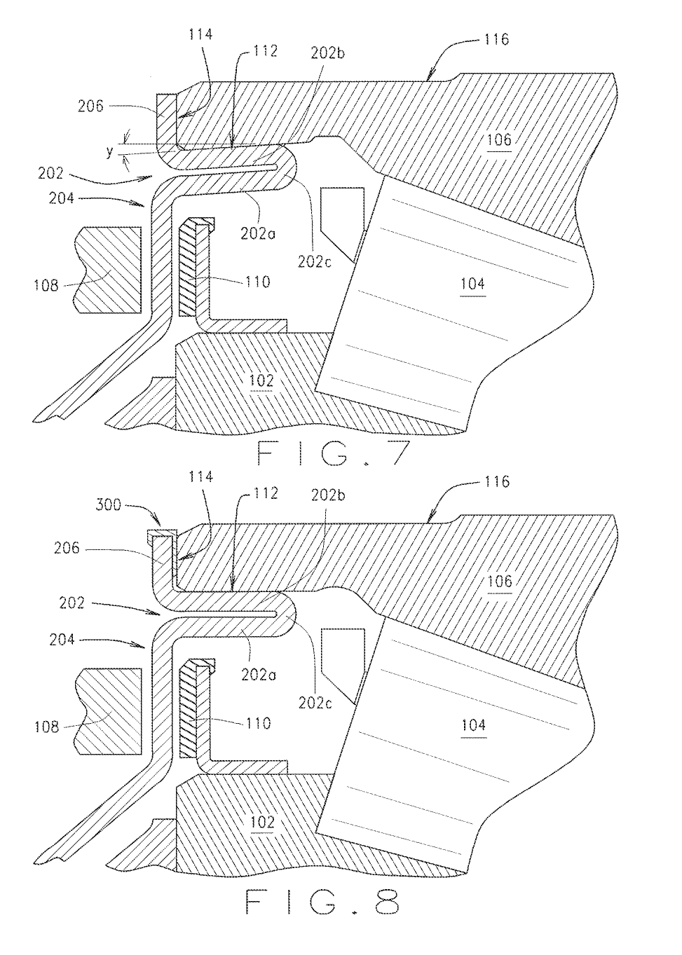

Retention of the endcap 200 with the outer axial member 106 may be further facilitated by modifications to the annular pilot structure 202. For example, as shown in FIG. 6, the annular bend 206c may be radially enlarged to positively engage with an annular recessed portion 112a on the inner peripheral surface 112 of the outer axial member 106. Alternatively, the pilot structure 202 itself, or just the radially-outside annular portion 202b, may be formed in an outwardly-opening frustoconical configuration relative to the wheel bearing assembly rotational axis X, as shown in FIG. 7, such that the endcap pilot structure 202 is resiliently deformed upon initial engagement of the endcap 202 with the wheel bearing assembly 100 during assembly. The initial resilient deformation provides a force directed radially outward, holding the endcap 200 in place within the inner peripheral surface 112 of the outer axial member 106 when fully seated.

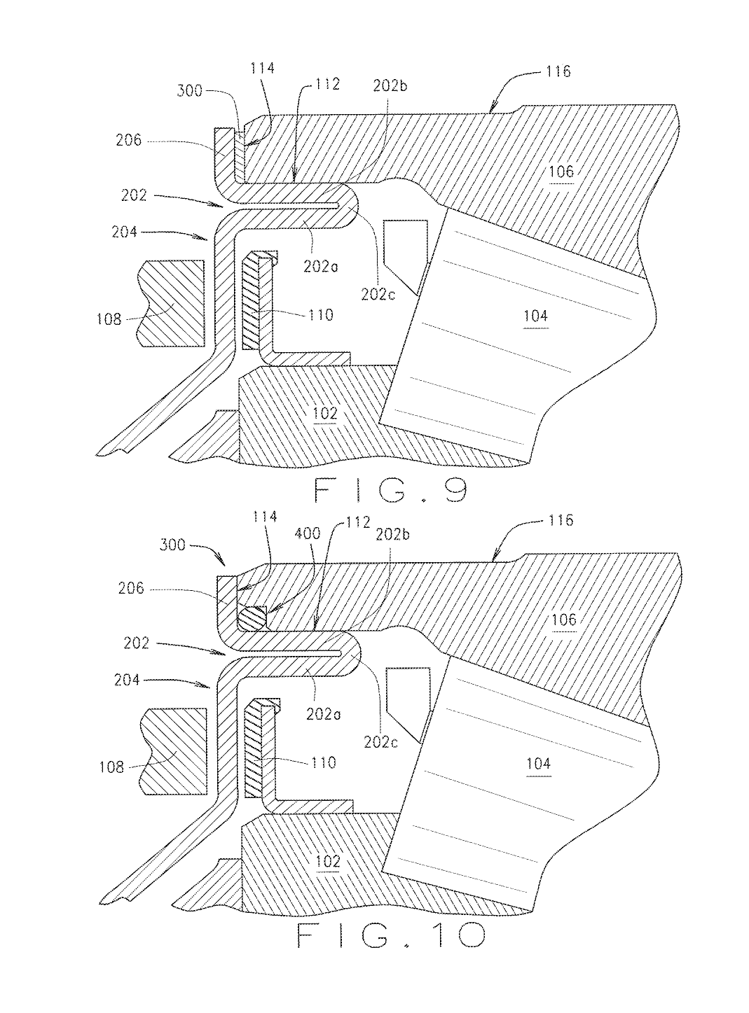

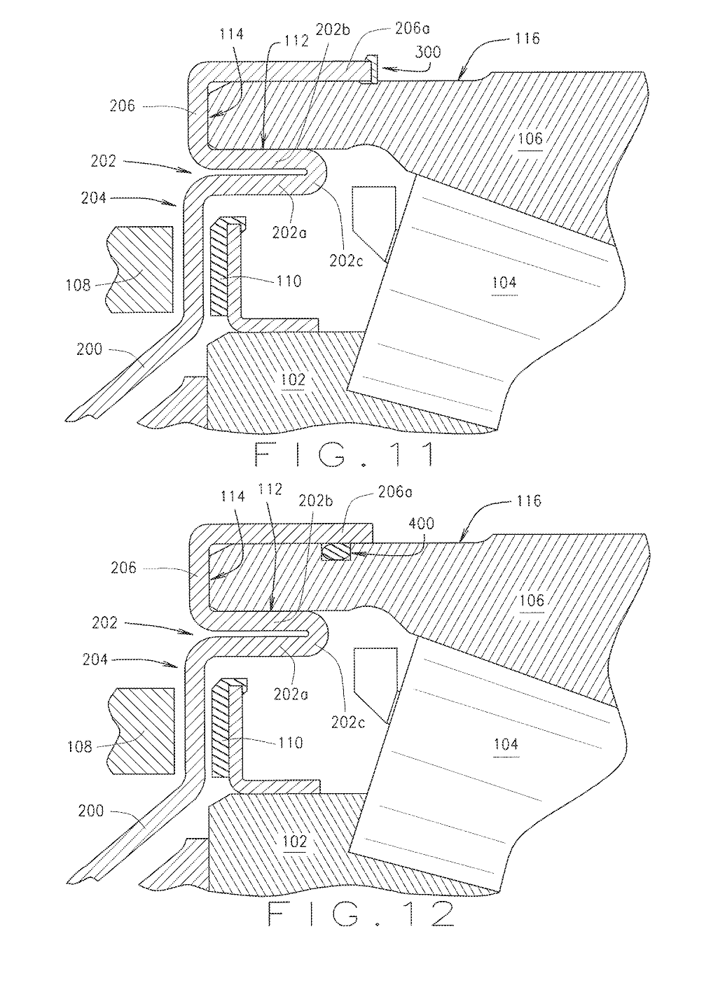

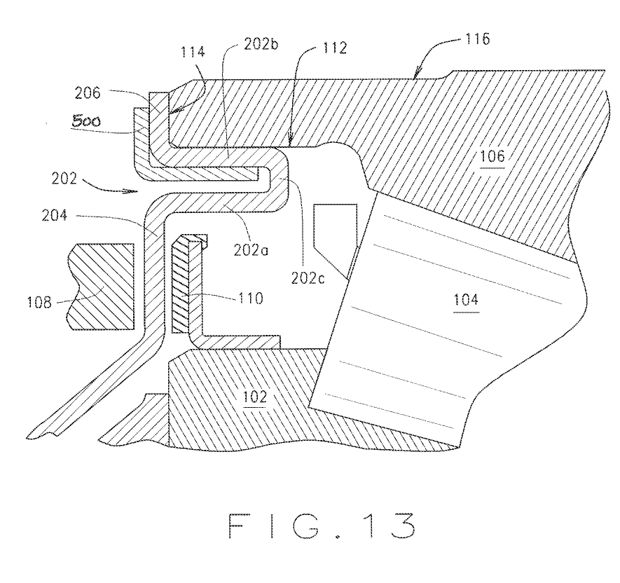

Additional sealing functionality, so as to prevent the ingress of contaminates into the bearing assembly 104, or the loss of lubricant there from, may be achieved by incorporating sealing elements, such as elastic seals 300, O-rings 400, gaskets, or other applied sealing materials between the abutting surfaces of the endcap 200 and the outer axial member 106. The additional sealing elements may be incorporated into any of the aforementioned variations of the endcap 200 of the present disclosure. For example, as seen in FIGS. 8 and 11, an elastomeric seal 300 may be fitted about the outer peripheral surface of the outer annular flanges 206, 206a, or seated between the outer annular flange 206 and the inboard end face 114 of the outer axial member 106, as seen in FIG. 9. Alternatively, O-ring seals may be disposed within recesses in the surfaces 112, 114, and 116 of the outer axial member 106, as seen in FIGS. 10 and 12.

For embodiments wherein the endcap 200 is composed of a lightweight plastic material, an additional annular stamping 500 may be utilized to facilitate retention of the pilot structure 202 within the inner surface 112 of the outer axial member 106. As seen in FIG. 13, the stamping 500 is a generally rigid annular member having both axial and radial portions, sized to fit within the inboard recess of the pilot structure 202, acting as a reinforcing member to secure the pilot structure 202 in place against the inner surface 112 and the inboard axial end 114. Preferably, the annular stamping is formed from steel, but other suitable materials may be utilized as well without departing from the scope of the invention.

As various changes could be made in the above constructions without departing from the scope of the disclosure, it is intended that all matter contained in the above description or shown in the accompanying drawings shall be interpreted as illustrative and not in a limiting sense.

1. An endcap (200) for enclosing an inboard end of a vehicle wheel bearing assembly (100) having a inner axial member (102) rotationally supported about an axis of rotation (X) by an annular bearing assembly (104) relative to a outer axial member (106), comprising:
an endcap central surface (204);
an outer peripheral flange (206) surrounding said endcap central surface (204), said outer peripheral flange (206) configured to abut an inboard axial face (114) of the outer axial member (106) to facilitate sealing of the enclosed vehicle wheel bearing assembly (100);
a pilot structure (202) disposed between said endcap central surface (204) and said outer peripheral flange (206), said pilot structure (202) defining a resilient annular spring means configured for fitment within an inner diameter surface (112) of the wheel bearing assembly outer axial member 106 to facilitate retention of said endcap (200); and
further including an annular retaining member (500) fitted within the inboard surface of said pilot structure (202).

2. The endcap of claim 1 wherein said pilot structure (202) is contiguously defined by an annular fold projecting axially in the outboard direction, said pilot structure having a radially-inside annular portion (202a) contiguous with said endcap central surface (204) and a radially-outside annular portion (202b) contiguous with said outer peripheral flange (206), said radially-inside annular portion (202a) and said radially outside annular portion (202b) disposed in a generally parallel configuration and coupled at an outboard end by an annular bend (202c).

3. The endcap of claim 2 wherein said resilient annular spring means is formed by said radially-inside annular portion (202a), said radially-outside annular portion (202b), and said annular bend (202c).

4. The endcap of claim 3 wherein said annular bend (202c) includes a radially enlarged portion adapted to positively engage an annular recessed portion (112a) on the inner diameter surface (112) of the wheel bearing assembly outer axial member (106).

5. The endcap of claim 2 wherein said resilient annular spring means is configured to bias the radially-outside annular portion (202b) against said inner diameter surface (112) of the wheel bearing assembly outer axial member (106).

6. The endcap of claim 1 wherein said abutment of said outer peripheral flange (206) with said inboard axial face (114) of the wheel bearing assembly outer axial member (106) provides a positive axial stop for fitment of said endcap (200) to said wheel bearing assembly (100).

7. The endcap of claim 1 wherein said endcap central surface (204) is configured to enable an external sensor (108) to obtain signals through said endcap central surface (108) from an encoder (110) disposed behind the endcap central surface (204), said encoder (110) disposed within the wheel bearing assembly (100) between the endcap pilot structure (202) and said inner axial member (102).

8. The endcap of claim 7 wherein a radial width of the endcap pilot structure (202) is selected to accommodate said encoder (110).

9. The endcap of claim 1 wherein said outer peripheral flange (206) is configured with a portion (206a) to extend past, and wrap around, an outer diameter surface (116) of the wheel bearing assembly outer axial member (106), further facilitating sealing of the wheel bearing assembly (100) from external contaminates.

10. The endcap of claim 9 wherein an outboard end (208a) of the outer peripheral flange portion (206a) is flared outward from the outer diameter surface (116).

11. The endcap of claim 9 wherein an outboard end (208) of the peripheral flange portion (206a) is crimped to engaged with an annular recessed region (116a) in said outer surface (116) of the wheel bearing assembly outer axial member (106).

12. The endcap of claim 1 wherein said pilot structure (202) is inclined relative to the wheel bearing assembly rotational axis (X) to define an inboardly directed frustoconical surface for fitted engagement with the inner diameter surface (112) of the wheel bearing assembly outer axial member (106); and
wherein said pilot structure (202) is resiliently deformable.

13. The endcap of claim 1 further including one or more sealing components disposed between the endcap outer peripheral flange (206) or peripheral flange portion (206a) and the wheel bearing assembly outer axial member surface (114 or 116) to facilitate sealing of the wheel bearing assembly (100), said one or more sealing components selected from a set of sealing components including elastic seals (300), O-rings (400), and applied sealing materials.

14. An endcap (200) for enclosing an inboard end of a vehicle wheel bearing assembly (100) having a inner axial member (102) rotationally supported about an axis of rotation (X) by an annular bearing assembly (104) relative to a outer axial member (106), comprising:
an endcap central surface (204) concentrically disposed about said axis (X);
a pilot structure (202) contiguous with said endcap central surface (204), said pilot structure (202) configured for fitment within an inner diameter surface (112) of the wheel bearing assembly outer axial member (106) to facilitate retention of said endcap (200) within the inner diameter surface (112);
wherein said pilot structure (202) is further configured to provide an annular seal between said endcap (200) and said inner diameter surface (112) of the wheel bearing assembly outer axial member (106) to prevent contaminate ingress and lubricant egress;
an outer peripheral flange (206) contiguous with said pilot structure (202), radially opposite from said endcap central surface (204), said outer peripheral flange (206) configured to abut at least an inboard axial face (114) of the outer axial member (106) to provide an annular seal between said endcap (200) and said inboard axial face (114) of the wheel bearing assembly outer axial member (106) to prevent contaminate ingress and lubricant egress; and
further including an annular retaining member 500 fitted within the inboard surface of said pilot structure 202.

15. The endcap of claim 14 wherein said outer peripheral flange (206) is configured with a portion (206a) to extend radially past, and wrap around in an axially outboard direction, an outer diameter surface (116) of the wheel bearing assembly outer axial member (106) to provide an annular seal between said endcap (200) and said outer diameter surface (116) of the wheel bearing assembly outer axial member (106) to prevent contaminate ingress and lubricant egress.

16. (canceled)

17. The endcap of claim 1 wherein said annular retaining member is a rigid annular member, having an axially projecting portion sized for fitment within the inboard surface of said pilot structure, and an outwardly radially projecting lip for seating against said outer peripheral flange.

18. The endcap of claim 1 wherein said annular retaining member secures said pilot structure against said inner diameter surface of the wheel bearing assembly outer axial member.

19. The endcap of claim 1 wherein said annular retaining member is formed from steel.

20. The endcap of claim 1 wherein said annular retaining member is a stamping.
